(19) United States
(12) Patent Application Publication
(10) Pub. No.: US 2006/0170688 A1
(43) Pub. Date: Aug. 3, 2006

(54) Time-dependent animation of a 3D object

(76) Inventor: Hassan Ugail, Bradford (GB)

Correspondence Address: Adams Evans P.A., 2180 Two Wachovia Center, 301 S. Tryon Street, Charlotte, NC, 28282, US

(21) Appl. No.: 11/072,065

(22) Filed: Mar. 4, 2005

(30) Foreign Application Priority Data
Feb. 1, 2005 (GB) GB 0502004.5

(51) Int. Cl. G06T 15/70

(52) U.S. Cl. 345/473

(57) ABSTRACT

A plurality of control curves P₁, P₂, d₁, d₂ are provided as boundary conditions to a partial differential equation. At least one of the boundary conditions is defined as a function of time t. Solving the partial differential equation with respect to the time-variant boundary conditions provides a surface patch of a 3D object which changes over time. A time-variant spine S may also be provided which coordinates manipulation of the control curves, thereby providing a time-based animation of the PDE surface patch.

### TECHNICAL FIELD AND BACKGROUND OF THE INVENTION

The present invention relates in general to a method and apparatus to animate a 3D object. In particular, the present invention relates to a method and apparatus to animate an object whose surface in represented by a Partial Differential Equation (PDE) surface patch.

### DESCRIPTION OF THE RELATED ART

As background to the present invention, a paper by Ugail H., Bloor, M. I. G., Wilson M. J.: TECHNIQUES FOR INTERACTIVE DESIGN USING THE PDE METHOD, ACM Transactions on Graphics, Vol. 18, No. 2, pp195-212 (dated 2 Apr. 1999), by the present inventor and others, discusses a shape modelling technique using a partial differential equation to describe the shape of a surface of an object. This is conveniently known as a PDE surface or a PDE surface patch.

Partial differential equations are themselves ubiquitous in science and are used to describe various different phenomena such as fluid flow, gravitational fields or electromagnetic fields. PDEs are useful in areas such as aircraft flight simulation and weather prediction, as well as theoretical explanations for general relativity and quantum mechanics. However, the use of PDEs to represent the shape of the surface of a 3D object is a relatively new and unexplored field, and is a substantial departure from traditional modelling techniques.

A PDE surface is defined by a plurality of boundary curves that impose boundary conditions on the partial differential equation. A complex surface shape is created by mathematically solving the PDE for those boundary conditions.

There is a need to create computer models of 3D objects which change their shape over time. That is, computer generated time dependent geometry, otherwise known as computer animation, relies upon the ability for a three dimensional object to deform into a series of other objects through time. Most currently available 3D modelling techniques involve the use of polylines and polygonal faceted representation of objects. Therefore, the modelling of time-dependent geometry within the computer animation field has mostly revolved around time based interpolation. Techniques such as key-framing allow a human animator to specify a base geometry and target geometry at specific key frames in a sequence. The computer animation tool, with the aid of an interpolation algorithm, fills in intermediate frames to create a smooth animation. However, key framing is labour intensive and has difficulties in creating realistic animation.

Another approach known in the art is the use of morphing, where a seamless correspondence between an initial base geometry and a target geometry is generated using blending functions. Other approaches include the use of finite-difference and finite elements for the integration of energy-based Lagrange equations. These and similar techniques have been successfully used to model time-dependent deformable bodies.

The existing systems for generating time dependent geometry of complex shapes are difficult to use and often do not allow direct control of the dynamic motion of an object. Typically there is a wide gap between the geometry generation tools used to create the object, and the animation tools used to animate the geometry.

### SUMMARY OF THE INVENTION

An aim of the present invention is to address the problems of the prior art, as expressed above or otherwise.

A preferred aim of the present invention is to provide a method and apparatus to animate a 3D object with realistic time-dependent geometry.

According to the present invention there is provided an apparatus and method as set forth in the appended claims. Preferred features of the invention will be apparent from the dependent claims, and the description which follows.

In one aspect of the present invention, a 3D object is represented by a plurality of control curves as boundary conditions to a partial differential equation. At least one of the boundary conditions is defined as being time-dependent. Preferably one of the control curves is defined to change shape and/or position as a function of time. Solving the partial differential equation over time for the time-dependent boundary conditions thereby provides a time-variant PDE surface patch of the 3D object.

In a preferred aspect of the present invention, a spine is provided which coordinates movement of the control curves. That is, repositioning the spine automatically redefines the set of control curves and thereby alters the shape of the represented 3D object. Optionally, the spine is defined with a time-dependent variation. Solving the PDE for the time-dependent spine causes coordinated changes in shape or position of the boundary conditions and hence animates the shape or position of the PDE surface patch over time. In a preferred embodiment the spine is derived as part of the solution to the PDE.

### BRIEF DESCRIPTION OF THE DRAWINGS

For a better understanding of the invention, and to show how embodiments of the same may be carried into effect, reference will now be made, by way of example, to the accompanying diagrammatic drawings in which:

FIG. 1 shows an example three-dimensional object;

FIGS. 2a and 2b show an example 3D object generated with a PDE surface patch;

FIGS. 3a and 3b show the example object of FIG. 2 following shape manipulation;

FIG. 4 is a schematic overview of a method to animate a 3D object in a preferred embodiment of the present invention;

FIGS. 5 & 6 illustrate a first example embodiment of time-dependent modelling of a 3D object;

FIGS. 7 and 8 show another preferred example to illustrate time-dependent modelling of a 3D object; and

FIG. 9 shows an example apparatus as employed in preferred embodiments of the present invention.

### DETAILED DESCRIPTION OF THE PREFERRED EMBODIMENT AND BEST MODE

The preferred embodiments of the present invention will now be described in detail by way of illustration.

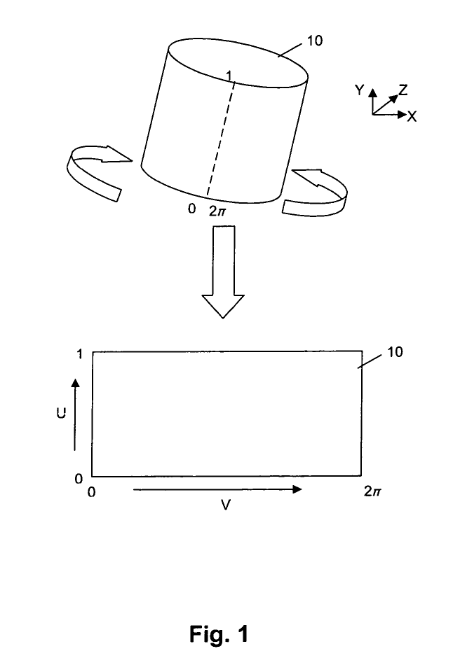

FIG. 1 shows an example three-dimensional object 10. In this case the object is a simple cylinder. In most three-dimensional graphical representations or 3D modelling systems, the object 10 is considered in terms of orthogonal X, Y and Z axes as shown in FIG. 1. On a 2D display surface such as a page of paper or a computer screen, Z is usually perpendicular to the plane of the display.

A PDE surface patch represents the surface of the object 10 by transforming from measurements in the X, Y, Z directions in FIG. 1 to instead represent the object in a parametric region defined by two parameters u and v such that any point on the surface X is given by an expression of the form:
X(u,v)=(x(u,v), y(u,v), z(u,v)) (1)

To try and illustrate this alternate approach of PDE surfaces, one can consider that the cylinder 10 has been cut open along its length and laid out flat. The shape of the surface is then defined in relation to the u,v parameter space.

In more detail, a PDE surface is a parametric surface patch X(u,v), defined as a function of two parameters u and v on a finite domain Ω⊂R², by specifying boundary data around the edge region of ∂Ω. Typically the boundary data are specified in the form of X(u,v) and a number of its derivatives on ∂Ω. Moreover, this approach regards the coordinates of the (u,v) point as a mapping from that point in Ω to a point in the physical space. In the preferred embodiment, X(u,v) is regarded as a solution of a PDE based on the elliptic bi-harmonic equation ∇⁴=0, namely

$${( \frac{{\partial }^{2}}{\partial {u}^{2}} + {a}^{2} \frac{{\partial }^{2}}{\partial {v}^{2}} )}^{2} \underline{X} ( u , v ) = 0. \qquad ( 2 )$$

Here the boundary conditions on the function X(u,v) and its normal derivatives ∂X/∂n are imposed at the edges of the surface patch. The parameter a is an optional design parameter employed in preferred embodiments of the present invention to control the relative smoothing of the surface in the u and v directions. That is, the parameter a produces a waist effect within the interior of the surface patch, with higher values of a producing a more pronounced waist effect. The parameter a is particularly useful when designing objects with an interactive graphical design tool (e.g. a CAD system).

Many methods are available to determine the solution of Equation (2), ranging from analytic solution techniques to sophisticated numerical methods. In the preferred embodiment described here restricting to periodic boundary conditions, a closed form analytic solution of Equation (2) is utilised.

Choosing the parametric region to be 0>u>1 and 0>v>2π, the periodic boundary conditions can be expressed as X(0,v)=P₁(v), X(1,v)=P₂(v), Xᵤ(0,v)=d₁(v), and Xᵤ(1,v)=d₂(v). The preferred PDE surface is controlled just by the control curves P₁,P₂ and d₁,d₂. These control curves may be open curves, or may be closed loops as in this example. The control curves may have a complex form, including sharp corners.

The boundary conditions P₁(v) and P₂(v) define the edges of the surface patch at u=0 and u=1 respectively. Using the method of separation of variables, the analytic solution of Equation (2) can be written as:

$$\underline{X} ( u , v ) = {\underline{A}}_{0} ( u ) + {\sum }_{n = 1}^{∞} [ {\underline{A}}_{n} ( u ) cos ( nv ) + {\underline{B}}_{n} ( u ) sin ( nv ) ] , \qquad ( 3 )$$

where
A₀(u)=a₀₀+a₀₁+a₀₂u²+a₀₃u³, (4)
Aₙ(u)=aₙ₁e^{anu}+aₙ₂ue^{anu}+aₙ₃e^{-anu}+aₙ₄ue^{-anu}, (5)
Bₙ(u)=bₙ₁e^{anu}+bₙ₂ue^{anu}+bₙ₃e^{-anu}+bₙ₄ue^{-anu}, (6)
where a₀₀,a₀₁,a₀₂,a₀₃,aₙ₁,aₙ₂,aₙ₃,aₙ₄,bₙ₁,bₙ₂,bₙ₃ and bₙ₄ are vector constants, whose values are determined by the imposed boundary conditions at u=0 and u=1.

For a general set of boundary conditions, in order to define the various constants in the solution, it is appropriate to Fourier analyse the boundary conditions and identify the various Fourier coefficients. Where the boundary conditions can be expressed exactly in terms of a finite Fourier series, the solution given in Equation (3) will also be finite. However, this is often not possible, in which case the solution will be the infinite series given Equation (3).

The preferred technique for finding an approximation to X(u,v) is based on the sum of the first few Fourier modes and a “remainder term”, i.e.,

$$\underline{X} ( u , v ) \approx {\underline{A}}_{0} ( u ) + {\sum }_{n = 1}^{N} [ {\underline{A}}_{n} ( u ) cos ( nv ) + {\underline{B}}_{n} ( u ) sin ( nv ) ] + \underline{R} ( u , v ) , \qquad ( 7 )$$

where N is usually small (e.g. N<10) and R(u, v) is a remainder function defined as,
R(u,v)=r₁(v)e^{wu}+r₂(v)e^{wu}+r₃(v)e^{-wu}+r₄(v)e^{-wu}, (8)
where r₁,r₂,r₃,r₄ and w are obtained by considering the difference between the original boundary conditions and the boundary conditions satisfied by the function

$$\underline{F} ( u , v ) = {\underline{A}}_{0} ( u ) + {\sum }_{n = 1}^{N} [ {\underline{A}}_{n} ( u ) cos ( nv ) + {\underline{B}}_{n} ( u ) sin ( nv ) ] , \qquad ( 9 )$$

Although the solution is approximate, this preferred solution technique guarantees that the chosen boundary conditions are exactly satisfied since the remainder function R(u,v) is calculated by means of the difference between the original boundary conditions and the boundary conditions satisfied by the function F(u,v).

It can be appreciated that, from a design point of view, this boundary curve based approach is a user-friendly tool for PDE surface manipulation in an interactive environment. The initial set of control curves are readily created such as by a designer freely drawing the curves or with click and drag operations. Further, the designer can readily manipulate the shape of the object simply by changing the shape and/or position of the control curves P₁, P₂ and d₁, d₂. For example, the designer operates the system to toggle between two display modes, or else the control curves are overlaid onto the resultant PDE surface. Manipulation of these boundary curves of a PDE surface is far simpler than other approaches to graphical modelling such as NURBS.

Whilst the control curves are simple and intuitive to create and to manipulate, in some circumstances it can become tedious for the designer to accurately shape and position each of the control curves, especially in a more complex object comprising many individual PDE surface patches.

Spine

The preferred embodiments of the present invention also provide a spine S which links each of the control curves P₁,P₂, d₁,d₂. The spine S can take many different forms.

In a first embodiment the spine S is a single straight line which intersects two or more control points associated with the control curves P₁, P₂ and d₁, d₂. In this example the control curves P, P₂, d₁, d₂ are each plane curves and the control points C₁, C₂, C₃, C₄ each lie in the plane of a respective control curve.

In a second embodiment the spine S comprises a set of straight lines as rigging between the control curves. That is, the spine S comprises first, second and third spine elements E₁, E₂, E₃ (i.e. vertebrae) each being a straight line between fixed points associated with two adjacent control curves. A plurality of spine control points C₁, C₂, C₃, C₄ are determined, conveniently each being a centroid in the plane of the respective control curve. The spine elements E₁, E₂, E₃ are conveniently each fixed length lines between the control points C₁, C₂, C₃, C₄.

In another preferred embodiment the spine S is a curve linking a set of predetermined control points in the plane of each of the control curves. That is, the spine S is a curve fitted to the spine control points C1,C2,C3,C4 from each of the control curves. For example, the spine is a Bezier curve or a B-Spline.

Spine Derivation

The preferred embodiment of the present invention derives the spine S as part of the solution of the partial differential equation defining the PDE surface. The spine S is extracted as a by-product of the solution and requires no additional computation.

Firstly, it has been identified that the term A₀ in Equation (3) is a cubic polynomial of the parameter u. Secondly it can be seen that for each point X(u,v) on the PDE surface the term Σₙ₌₁^{∞}[Aₙ(u)cos(nv)+Bₙ(u)sin(nv)] in Equation (3) describes the radial position of the point X(u,v) away from a point at A₀. Finally, applying the triangle inequality of Equation (3), one can see that,

$$‖ {\underline{A}}_{0} ( u ) ‖ \leq ‖ \underline{X} ( u , v ) ‖ + ‖ {\sum }_{n = 1}^{∞} [ {\underline{A}}_{n} ( u ) cos ( nv ) + {\underline{B}}_{n} ( u ) sin ( nv ) ] ‖ . \qquad ( 10 )$$

Thus, the term A₀ which is a cubic polynomial of the parameter u traces out a curve in 3-space which follows the “centreline” of the surface patch. Therefore, using the solution technique described above for Equation (3), a surface point X(u,v) may be regarded as being composed of sum of a vector A₀ giving the position on the spine of the surface and a radius vector defined by the term Σₙ₌₁^{∞}[Aₙ(u)cos(nv)+Bₙ(u)sin(nv)] providing the position of X(u,v) relative to the spine S. More precisely, for a PDE surface described by the Equation (3), the spine is constructed by taking that part of the solution with zero mean by way of removing the periodic contribution.

Although the particular definition for the spine of a PDE surface that is adopted here is very convenient from the point of view of the underlying mathematical representation of the surface, it is by no means a unique definition and alternative solutions are also applicable to the present invention.

As one alternative example, the spine is calculated as a centroid of the respective control curve. That is, the curve is taken to define the outline of a lamina having an equally distributed mass, and the centroid is calculated as the centre of gravity of the lamina. Hence, the spine has a predetermined association with the set of control curves. This association is predetermined such as by a centre of gravity of each control curve, or, as in the preferred embodiment, is derived from solving the partial differential equation.

It is noteworthy that the introduction of the R(u,v) term in the preferred solution described in Equation (7) hardly affects the interior shape of the surface. This is due to the fact that for larger n the Fourier modes make negligible contributions to the interior of the patch. Therefore, as far as the spine S of the shape generated using Equation (7) is concerned, since the spine does not represent the detailed geometry of the shape, the A₀(u) term is left unchanged by the introduction of the R(u,v) term in the approximate solution and hence the spine of the shape is left unchanged.

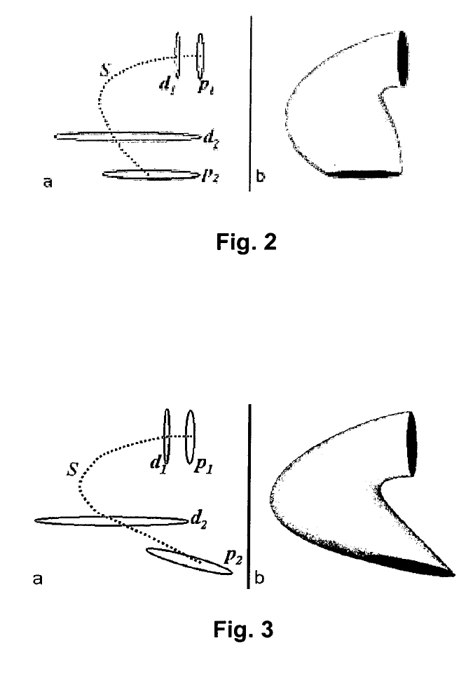

FIG. 2 shows an example 3D object. Boundary curves are created interactively as shown in FIG. 2a. Then, as shown in FIG. 2b, the corresponding 3D object surface is generated in real time by solving the PDE.

In some embodiments of the present invention, it is appropriate to create a new object by first drawing or defining the spine S, and then placing a plurality of control curves P₁,P₂,d₁,d₂ in relation to the spine. Alternatively, as described above for the preferred embodiments of the present invention, the boundary curves P₁,P₂,d₁,d₂ are defined first, and then the spine derived automatically as the A₀ term in the solution of Equation 3.

Shape Manipulation

One of the many attractive features of PDE surfaces is their ability to be able to create and manipulate complex shapes with ease. A user with little or no knowledge of solving PDEs and how the boundary conditions affect the solutions of the PDEs is able to create complex geometry with ease. The shapes in this case are parameterised using the boundary curves that define them. However, in order to manipulate the shape of very complex objects, the number of curve manipulations can be excessive. Since the spine S of the PDE surface characterises the surface patch as a whole, rather than individual boundaries, a shape parameterisation based on the spine provides further intuitive tools for shape manipulation.

In the preferred embodiments of the present invention the spine S is displayed, conveniently along with the control curves P₁,P₂ and d₁,d₂. A designer then has the option of manipulating the curves using the spine S.

That is, in some instances it is appropriate to adjust the spine to manipulate the object. In other circumstances it is preferable to alter one or more of the control curves to manipulate the object, and in doing so thereby also adjust the spine.

FIG. 3 shows the example 3D object of FIG. 2 after a geometry manipulation has been carried out.

As discussed above, manipulation of the spine S is a powerful and intuitive mechanism to manipulate the shape of a PDE surface. There are many ways in which the spine can be utilised in various different embodiments of the invention. A particularly preferred mechanism for defining and manipulating the spine S will now be described in more detail.

Preferably, the spine S is the cubic polynomial described by the A₀ term in Equation (3), and is considered to be a Hermite curve of the form
H(u)=B₁(u)p₁+B₂(u)p₂+B₃(u)v₁+B₄(u)v₂ (11)
where the Bᵢ are the Hermite basis functions, and the vectors P₁, P₂ and v₁,v₂ define the position and the speed of the Hermite curve at u=0 and u=1 respectively. By comparing the Hermite curve given in Equation (11) with the cubic for the spine S given as the A₀ term in Equation (3), the vector constants a₀₀, a₀₁, a₀₃ given in Equation (4) can be related to the position vectors and its derivatives at the end points of the spine S. Since the A₀ term in Equation (3) is an integral part of the preferred solution that generates the surface shape, any change in the shape of the spine S will have a resulting change in the shape of the surface.

A useful mechanism to change the shape of the spine S is to manipulate its position and the derivative at the two end points. Therefore, the position vectors and its derivatives at the end of points of the Hermite curve describing the spine are defined to be a new set of shape parameters that enable manipulation of the shape in an intuitive fashion.

Time-Dependent Geometry

As discussed above, PDE surfaces are readily manipulated by varying the chosen parameters, in terms of the boundary curves defining the shape and through the use of the spine. Notably, only relatively few design parameters are required in order to define the PDE surface. Efficient shape parameterisation of time dependent geometry is now possible by taking those design parameters to be functions of time. That is, time dependent geometric models can be made whose motion is controlled using the boundary curves and/or the spine as design parameters which define the shape of a PDE surface.

Further, the semi-analytic solution technique described above enables fast generation of object geometry. Preferred embodiments of the present invention are able to calculate a PDE surface in a fraction of a second when running on commonly available computing resources such as a desktop PC. Hence, the preferred embodiments of the present invention readily enable real-time animations.

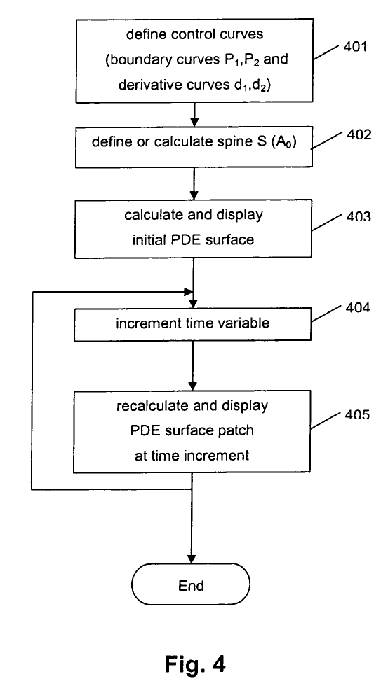

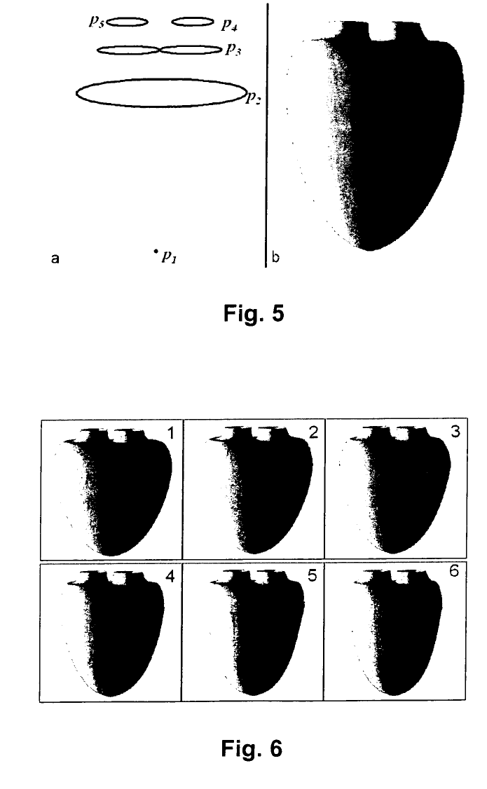

FIG. 4 is a schematic overview of a method to animate a 3D object in a preferred embodiment of the present invention.

In FIG. 4, a 3D object is created by defining a plurality of control curves and optionally a spine. At least one of the control curves and/or the spine is defined with a time dependent variable (steps 401 & 402). An initial PDE surface of the 3D object is calculated and displayed (step 403). The time variable is then updated, which alters the boundary conditions of the control curves and/or the spine (step 404). The PDE surface is then recalculated and displayed at the time increment (step 405). Successive time increments progressively modify the PDE surface patch of the 3D object, giving a time-dependent animation.

### EXAMPLE 1

### Beating Heart

FIGS. 5 & 6 illustrate a first example embodiment of time-dependent shape parameterisation using PDE surfaces by realistically modelling the left ventricle of the human heart.

Referring firstly to FIG. 5, this example heart geometry involves four separate PDE surface patches which are joined with common boundaries. FIG. 5a shows the position boundary curves defining the entire ventricle shape. The corresponding derivative curves have been omitted from the drawing for clarity. As discussed above, the derivative curves are generated by transforming the corresponding position curves. In the cases where the surface patches meet each other, the derivative curves are taken to ensure tangent plane continuity between the PDE surface patches.

As shown in FIG. 5a, the four surface patches making up the heart geometry are created using separate PDE surface patches between the curves P₁ & P₂, P₂ & P₃, P₃ & P₄ and P₃ & P₅, respectively. The curve P was initially taken to be a circle whose radius was then reduced to zero to create a point in 3-space. The curve P₃ is a single curve formed by joining two ellipses where the left ellipse and the curve P₅ and the right ellipse and the curve P₄ form two separate surface patches.

FIG. 5b shows the resultant 3D object obtained by solving the PDE for the respective control curves of FIG. 5a.

A mathematical description of the time-dependent motion of the left ventricle of the heart has been provided previously in a paper by Smith, J. J. and J. P Kampine: Circulatory Physiology, The Essentials, Williams and Wilkins, Baltimore, 1990. A heartbeat essentially involves three components of motion, namely axial contraction, radial contraction and twisting motion. To model these three modes of motion with realistic changes in volume and dimension of the heart, time-dependent parameters are defined based on the boundary conditions where t represents time as follows:
p₂(v,t)=(x₂+r₂(t)cos(v+α(t)),y₂+r₂(t)sin(v+α(t)),z₂=z(t)) (12)
p₃(v,t)=(x₃+r₃(t)cos(v+α(t))sin(v+α(t)),y₃+r₃(t)sin(v+α(t)),z₃-z(t)) (13)
p₄(v,t)=(x₄+r₄ cos(v+α(t)),y₄+r₄ sin(v+α(t),zₜₒₚ-z(t)) (14)
p₅(v,t)=(x₅+r₅ cos(v+α(t)),y₅+r₅ sin(v+α(t),zₜₒₚ-z(t)) (15)
where
z(t)=z_{ch} sin²(tπ/tₘ) (16)
r₂(t)=r₂(1-r_{ch} sin²(tπ/tₘ) (17)
r₃(t)=r₃(1-r_{ch} sin²(tπ/tₘ) (18)
and
α(t)=α_{ch} sin²(tπ/tₘ) (19)

The parameter tₘ is the time period of a typical cardiac cycle which was taken to be 0.8. The function z(t) controls the axial contraction where the parameter r_{ch} was taken to be 0.7. Similarly, the function r(t) controls the radial contraction where the parameter r_{ch} was taken to be 0.3. Finally the twisting motion is generated via the parameter α(t) with α_{ch} accounting for the amount of twist in the ventricle. Here the value of α_{ch} was taken to be π/4.

With the above parameters describing the dynamics of heart it is seen that realistic animations accounting for the changes in the volume and dimension of the ventricle for a typical cardiac cycle can be generated in real time.

FIG. 6 shows a series of images to illustrate the resultant time-dependent animation. Note that the twisting motion, although incorporated in the parameterisation, does not produce prominent changes in the geometry and is not readily observed in the images shown in FIG. 6.

### EXAMPLE 2

### Swimming Dolphin

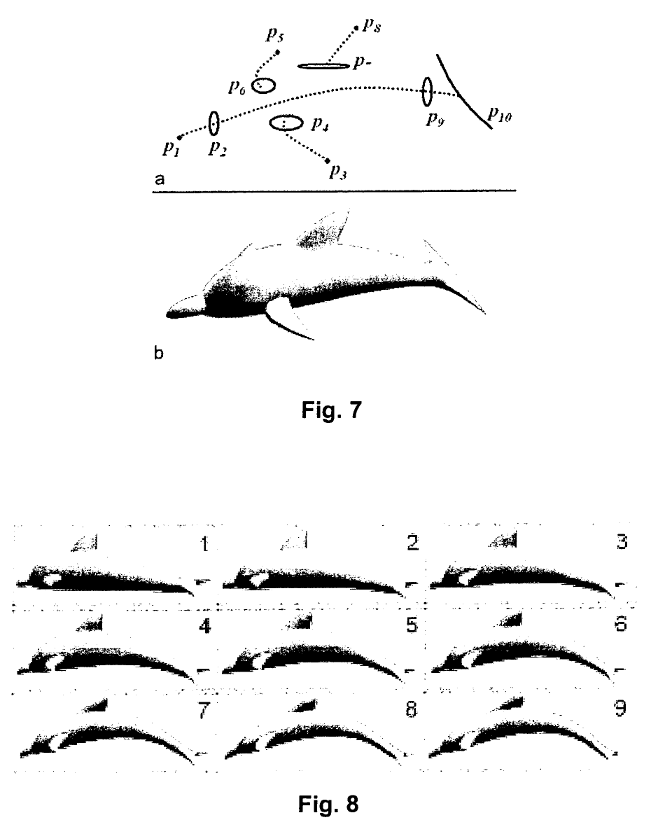

FIGS. 7 and 8 show another preferred example to illustrate time-dependent modelling to create realistic animation of a real world 3D object.

It is a relatively challenging task to animate natural movements. However, using the method and apparatus of the present invention it becomes possible to realistically model natural motions.

A mathematical description of the locomotion of aquatic mammals has been described previously by Lighthill, M. J., Hydrodynamics of aquatic animal propulsion, Ann. Rev. Fluid Mech. 1 (1969), 413-446. Here it is described that undulatory body motions impart momentum to their surroundings. Such aquatic body deformation generally involves three modes of movement including steady swimming, rapid starting and turning. The present example of the swimming dolphin models a steady swimming motion, but the same modelling techniques are applicable in many other situations.

FIG. 7a shows a set of position curves to generate a generic shape of a dolphin using six separate PDE surface patches. Like the previous example, only the position curves are shown here and the derivative curves have been omitted from the drawing for clarity. The curves P₁, P₃, P₅ and P₈ are circles of zero radius to form points in 3-space. The curves P₂ and P₉ defining the main body of the dolphin are appropriately chosen ellipses. The curve P₁₀ representing the tail was created using a cubic B-spline curve having a shape determined using fluke measurements for Common Dolphins. The curves P₄, P₆ and P₇ which form the body attachment for the lateral fins and the dorsal fin respectively lie on the main body surface where the portions have been trimmed off from the main body surface. These trimming processes were performed through the use of the (u,v) parameter space using known techniques. The broken lines in FIG. 7a show the spines associated with each PDE surface patch. The spines representing the beak, main body and flukes form a continuous curve which is referred to below as S_{d}(u). Continuity in the spines forming curve S_{d}(u) is asserted by ensuring that tangent continuity is always maintained at the points where the curves meet.

To model the dynamic body deformation for the steady swimming motion, the curve S_{d}(u) is taken to represent the backbone of the dolphin. Since the backbone is flexible, S_{d}(u) is taken to be a time dependent piecewise linear curve B(u,t) consisting of n segments of length L where t is time. Thus, taking the shape of the rest position of the dolphin's backbone spine to be S_{d}(u), the polynomial B(u,t) interpolates n+1 control points Bᵢ(u,t),l=1, . . . ,n+1 where the control points are constrained so as the Euclidean distance between the adjacent points is L/n. The flexibility along the backbone is controlled by associating an angle θᵢ for the first n control points of Bᵢ(u,t) such that the difference between adjacent angles is defined as a control parameter. In order to model the steady undulatory motion, the angle θᵢ is modulated along the spine according to a general travelling sine wave given as,
Bᵢ(u,t)=Ωs_{d}(u)sin((2π/λ)(s_{d}(u)−αt)) (20)
with
θᵢ=tan⁻¹((δBᵢ(u,t))/δu) (21)

With the above formulation, the steady motion of the dolphin illustrated in FIG. 7 was simulated by taking Ω=2.1, λ=1.1, α=0.5 and taking the rest position of the combined spine S_{d}(u) to lie along the y-axis of the 3-space.

FIG. 8 shows a series of images illustrating the motion of the dolphin, produced by solving the PDE surface patches at consecutive points in time.

Apparatus

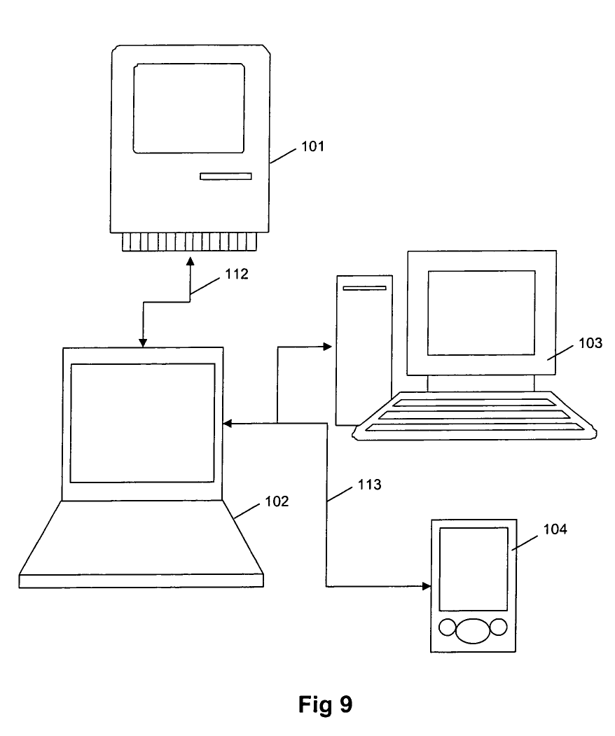

FIG. 9 shows an example apparatus as employed in preferred embodiments of the present invention.

As shown in FIG. 9, the preferred apparatus provides a computer-aided tool for design, modelling or animation of 3D objects. A display unit displays images to a user, and an input unit such as a keyboard, mouse, graphics pad or other suitable arrangement receives commands from the user, to create and manipulate the 3D object through the control curves and/or spine as discussed above. Further, the apparatus suitably comprises a processing unit to perform the animation and modelling techniques described herein.

The apparatus may be constructed from dedicated hardware, such as a dedicated graphics processor within a computer platform. Alternatively, the present invention is implemented as computer software running on a general purpose computer platform. Further, the present invention extends to a storage medium containing machine-readable instructions to perform the design, modelling and animations described herein.

Referring again to FIG. 9, it is desired to store data representing 3D objects within one or more computing platforms 101-104. Also, it is desired to send and receive data representing 3D objects between the computing platforms 101-104 such as over a local network 112 or a wide area network 113. The networks 112,113 may take any suitable form and may include wired and/or wireless communications as will be familiar to those skilled in the art. In each case it is desired that the object data be relatively compact, whilst still providing a full and detailed representation of a 3D object.

In preferred embodiments of the present invention, a data storage format mathematically defines the each of control curves, such as with the example equations shown above. Also, the spine is suitably mathematically defined, such as with Fourier coefficients or other suitable curve data format. By sending just the control curves and optionally the spine, the data storage format is very compact. However, a recipient is immediately able to recreate the animated 3D object with each PDE surface patch exactly and confidently described by the respective boundary conditions to the partial differential equation.

Although a few preferred embodiments have been shown and described, it will be appreciated by those skilled in the art that various changes and modifications might be made without departing from the scope of the invention, as defined in the appended claims.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

I claim:

1. A method to animate a 3D object, comprising the steps of:
providing a plurality of control curves as boundary conditions to a partial differential equation;
defining a manipulation of at least one of the boundary conditions as a function of time; and
solving the partial differential equation with respect to the plurality of control curves over time, to provide a surface patch of a 3D object which changes over time.

2. The method of claim 1, wherein the defining step comprises defining at least one of the plurality of control curves using a curve equation which is time-dependent.

3. The method of claim 1, further comprising:
providing a spine associated with the plurality of control curves; and
manipulating the spine as a function of time to cause coordinated manipulation of the plurality of control curves.

4. The method of claim 3, further comprising:
manipulating the spine as a function of time, and in response adjusting a position and/or shape of the plurality of control curves to maintain a predetermined association with the spine.

5. The method of claim 1, wherein:
the partial differential equation is of the form
$${( \frac{{\partial }^{2} }{\partial {u}^{2}} + {a}^{2} \frac{{\partial }^{2}}{\partial {v}^{2}} )}^{2} \underline{X} ( u , v ) = 0.$$
where u and v are parameters of the surface patch; and
solving the partial differential equation over the u,v parameter space provides the surface patch as a plurality of surface points in three dimensional space.

6. The method of claim 1, wherein the plurality of control curves include at least two position curves P₁ and P₂ which correspond to boundary conditions on the function X (u,v), where P₁(v)=X(0,v) and P₂(v)=X(1,v), and a vector field corresponding to the difference between the position curves P₁ and P₂ and respective difference curves d₁ and d₂, corresponds to the conditions on the function ∂X/∂n such that ∂x/∂n=[p(v)−d(v)]s, where s is a scalar.

7. The method of claim 1, further comprising the step of storing the surface patch as a set of surface points, and rendering the surface patch on a user display screen using the stored set of surface points.

8. The method of claim 1, wherein:
the partial differential equation is of the form
$${( \frac{{\partial }^{2} }{\partial {u}^{2}} + {a}^{2} \frac{{\partial }^{2}}{\partial {v}^{2}} )}^{2} \underline{X} ( u , v ) = 0.$$
where u and v are parameters of the surface patch;
the plurality of control curves include at least two position curves P₁ and P₂ which correspond to boundary conditions on the function X(u,v), where P₁(v)=X(0,v) and P₂(v)=X(1,v), and respective difference curves d₁ and d₂; and
the spine is given by the term A₀(u) derived by solving the partial differential equation in the form:
$$\underline{X} ( u , v ) = {\underline{A}}_{0} ( u ) + {\sum }_{n = 1}^{∞} [ {\underline{A}}_{n} ( u ) cos ( nv ) + {\underline{B}}_{n} ( u ) sin ( nv ) ] ,$$
where
A₀(u)=a₀₀+a₀₁+a₀₂u²+a₀₃u³,
Aₙ(u)=aₙ₁e^{anu}+aₙ₂ue^{anu}+aₙ₃e^{-anu}+aₙ₄ue^{-anu},
Bₙ(u)=bₙ₁e^{anu}+bₙ₂ue^{anu}+bₙ₃e^{-anu}+bₙ₄ue^{-anu},
where a₀₀,a₀₁,a₀₂,a₀₃,aₙ₁,aₙ₂,aₙ₃,aₙ₄,bₙ₁,bₙ₂,bₙ₃ and bₙ₄ are vector constants, whose values are determined by the boundary conditions at u=0 and u=1.

9. The method of claim 8, further comprising:
describing the spine as a Hermite curve of the form
H(u)=B₁(u)p₁+B₂(u)p₂+B₃(u)v₁+B₄(u)v₂
where Bᵢ are Hermite basis functions, and vectors p₁, p₂ and v₁,v₂ define a position and speed of the Hermite curve at u=0 and u=1 respectively; and
changing the spine by manipulating its position vectors p₁, p₂ at two end points thereof and/or its respective speed vectors v₁,v₂.

10. A computer-aided design tool, comprising:
a display unit to display images to a user;
an input unit to receive user manipulation commands from the user; and
a processor unit to perform the steps of:
providing a plurality of control curves as boundary conditions to a partial differential equation;
defining a manipulation of at least one of the boundary conditions as a function of time; and
solving the partial differential equation with respect to the plurality of control curves over time, to provide a surface patch of a 3D object which changes over time.
